(19) United States
(12) Patent Application Publication
(10) Pub. No.: US 2011/0191446 A1
(43) Pub. Date: Aug. 4, 2011

(54) STORING AND STREAMING MEDIA CONTENT

(75) Inventors: Alain Dazzi, San Jose, CA (US); Arun Krishnan, Cupertino, CA (US)

(73) Assignee: CLARENDON FOUNDATION, INC., Murray, UT (US)

(21) Appl. No.: 13/014,881

(22) Filed: Jan. 27, 2011

Related U.S. Application Data
(60) Provisional application No. 61/299,549, filed on Jan. 29, 2010.

(51) Int. Cl. G06F 15/16

(52) U.S. Cl. 709/219

(57) ABSTRACT

Providing media content includes storing a plurality of media files on a storage tier having at least one storage cluster, each storage cluster having at least one server, replicating at least some of the media files stored on the storage tier on at least one streaming server of a streaming tier configured to stream data over a network faster than the storage tier is able to stream the data over the network; receiving a request from a client over the network for a portion of a selected media file; streaming the requested portion of the selected media file to the client from the streaming tier if the selected media file is stored on the streaming tier; and streaming the requested portion of the selected media file to the client from the storage tier if the media file is not stored on the streaming tier.

### CROSS-REFERENCE TO RELATED PATENT APPLICATIONS

The present application claims priority under 35 U.S.C. §119(e) to U.S. Provisional Patent Application Ser. No. 61/299,549, which was filed on Jan. 29, 2010.

### TECHNICAL FIELD

The present disclosure relates generally to computers and computer-related technology. More specifically, the present disclosure relates to a multi-tiered architecture for storing and streaming media content.

### BACKGROUND

Computer and communication technologies continue to advance at a rapid pace. Indeed, computer and communication technologies are involved in many aspects of a person's day. Computers commonly used include everything from hand-held computing devices to large multi-processor computer systems.

Computers are used in almost all aspects of business, industry and academic endeavors. More and more homes are using computers as well. The pervasiveness of computers has been accelerated by the increased use of computer networks, including the Internet. These computers are often interconnected to form a computer network. One or more servers may provide data and services for other client computers on a network. The client computers are often referred to as clients. A computer network may include hundreds or even thousands of clients.

Content distribution networks (CDNs) provide media content (e.g. audio, video) streaming services to end users. Content providers desire their media content to be available to end users jitter-free and without error. However, CDNs may only offer limited bandwidth. Thus, improved systems and methods may provide media content to end users at an optimal rate allowing smooth and error-free media content streaming.

As shown from the above discussion, there is a need for systems and methods that will improve the storing and streaming of media content. Improved systems and methods are disclosed herein.

### BRIEF DESCRIPTION OF THE DRAWINGS

FIG. 1 is a block diagram illustrating a network of connected devices including a media content storage and streaming provider according to one exemplary embodiment of the principles described herein.

FIG. 2 is a block diagram illustrating a multi-tiered storage architecture for storing and streaming media content according to one exemplary embodiment of the principles described herein.

FIG. 3 is a flow diagram illustrating a method for storing and streaming media content according to one exemplary embodiment of the principles described herein.

FIG. 4 is a block diagram illustrating a multi-tiered architecture for storing and streaming media content according to one exemplary embodiment of the principles described herein.

FIG. 5 is a flow diagram illustrating a method for storing media content for streaming according to one exemplary embodiment of the principles described herein.

FIG. 6 is a block diagram illustrating the distribution of a media file in a storage structure for streaming media content according to one exemplary embodiment of the principles described herein.

FIG. 7 is a flow diagram illustrating a method for streaming media stored on a multi-tiered storage structure according to one exemplary embodiment of the principles described herein.

FIG. 8 is a block diagram of an illustrative method of streaming a media file to an intelligent client according to one exemplary embodiment of the principles described herein.

FIG. 9 is a block diagram illustrating media store services located on a media content storage and streaming provider according to one exemplary embodiment of the principles described herein.

FIG. 10 is a block diagram illustrating a directory structure according to one exemplary embodiment of the principles described herein.

FIG. 11 is a block diagram illustrating various components that may be used in a media content storage and streaming provider according to one exemplary embodiment of the principles described herein.

FIG. 12 illustrates various components that may be utilized in a storage server, streaming server, and/or client according to one exemplary embodiment of the principles described herein.

### DETAILED DESCRIPTION

Content distribution networks may commonly be used to provide video streaming services to end users. A content distribution network may be a group of computer systems working to cooperatively deliver content quickly and efficiently to end users over a network. End users may be able to access a wide variety of content provided by various content producers. To compete for viewing time, content producers desire their media content to be available to end users through high-quality video and audio with minimal delays and stalling. Accomplishing this goal may require collaboration from a variety of networking equipment and storage systems. Such equipment and systems may only be capable of providing a limited bandwidth to end users. As a result, media content may often be compressed using a variety of algorithms to reduce the amount of data required for streaming. However, media content may only be compressed to a certain extent. Thus, it may be desirable to develop efficient structures and collaboration mechanisms which will provide media content to end users at an optimal rate required to maintain quality of service and experience for streaming. Providing more media content data at an optimal rate may allow smooth and high-quality media content streaming, thereby enhancing user viewing experience.

The present specification relates to a data storage structure which may provide mechanisms for increasing the efficiency at which media content may be streamed to end users. According to one configuration, a data storage structure may include an archive tier, at least one storage tier, and a streaming tier. All media content available for streaming may be stored in the archive tier. That media content may also be distributed across multiple storage clusters making up the storage tier. The streaming servers may then retrieve data for a media content file from multiple storage clusters. The streaming servers may then stream the media content file to client systems. Through use of a data storage structure using principles described herein, media content streaming may be provided to end users at an optimal rate and with more reliability.

Previous content delivery architectures may have potential performance bottlenecks that could affect scalability and performance delivery. By contrast, the architecture for content delivery disclosed in the present specification may alleviate this performance and throughput bottleneck and may be capable of scaling up to support a large number of content streams from a point of presence (POP). A multi-tier media storage architecture with content distributed across a streaming tier and a storage tier is disclosed. Content may be dynamically moved and synchronized to the streaming tier servers based on access frequency and media content profile.

Thus, a data storage structure for a content distribution network may be configured so as to provide horizontal scalability and increased system performance and throughput. This may be accomplished using a tiered data storage structure. The data storage structure may include an archive tier configured to store media content, a storage tier connected to archive tier, and a streaming server tier connected to the storage tier. The streaming server tier may be configured to stream media content to client systems.

Various configurations of the system are now described with reference to the Figures, where like reference numbers indicate identical or functionally similar elements. The systems and methods, as generally described and illustrated in the Figures herein, could be arranged and designed in a wide variety of different configurations. Thus, the following more detailed description of several configurations of the system, as represented in the Figures, is not intended to limit the scope of the invention, as claimed, but is merely representative of various system configurations.

Many features of the system configurations disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device. Software that implements the functionality associated with components described herein may comprise a single instruction, or many instructions, and may be distributed over several different code segments, among different programs, and across several memory devices.

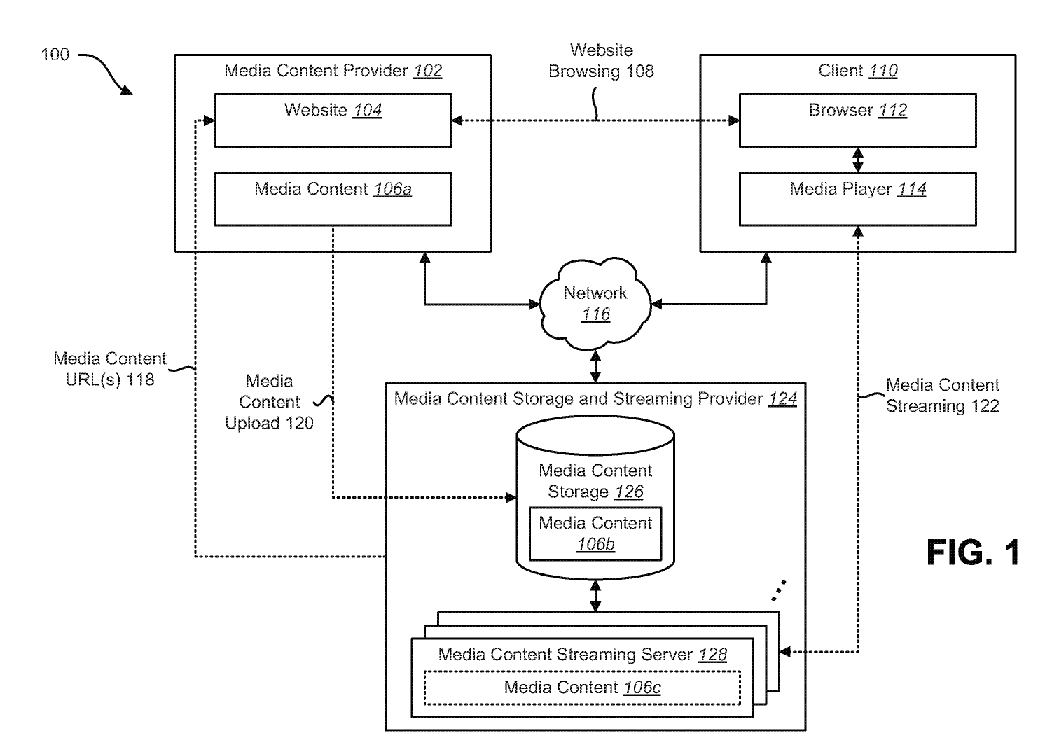

FIG. 1 is a block diagram illustrating a network of connected devices 100 including a media content storage and streaming provider 124. A media content provider 102, a media content storage and streaming provider 124 and a client 110 may be connected via a network 116 (e.g. an intranet, or the Internet). The media content provider 102 may include a website 104 and media content 106a. The media content storage and streaming provider 124 may include media content storage 126 and one or more media content streaming servers 128. The media content provider 102 may upload 120 the media content 106a to the media content storage and streaming provider 124. The media content storage and streaming provider 124 may store the media content 106b in the media content storage 126. The media content storage and streaming provider 124 may send one or more media content Uniform Resource Locators (URLs) 118 to the media content provider 102. The media content provider 102 may make the one or more media content URLs 118 available for its website 104. The media content storage and streaming provider 124 may copy or cache the media content 106c on the one or more media content streaming servers 128.

The client 110 may be a computing device. Examples of computing devices include, but are not limited to, a desktop computer, laptop computer, cell phone, smart phone, tablet, netbook, e-book (i.e. e-reader), personal digital assistant (PDA), game console, television, personal media player, and the like. The client 110 may include a browser 112 and a media player 114. The media player 114 is an application used to play media files (e.g. audio or video files). The media player 114 may be separate from the browser 112, or may be incorporated within the browser 112. The client 110 uses the browser 112 to browse 108 the website 104. The client 110 may select one or more media content URLs 118 on the website 104. The media player 114 may use the one or more URLs 118 to access one or more media content streaming servers 128. The one or more media content streaming servers 128 stream 122 the media content 106b, 106c associated with the one or more URLs, to the client 110. The media player 114 plays the streamed 122 media content 106b, 106c on the client 110.

As shown in FIG. 1, one possible use case for this system is when a provider of content wishes to provide this content to end users on the Internet, but further desires to have the hosting and streaming of the content provided by a service provider that specializes in the storage and streaming of media content, such as the media content storage and streaming provider 124. The media content provider 102 provides the content to the storage and streaming provider 124, which in turn typically provides URLs 118 to the media content provider 102 so that the content provider 102 can place the URLs onto its website 104. Users browsing 108 the website 104 may click on a thumbnail, for example, of a video that links to the URL 118 provided by the storage and streaming provider 124. The client browser 112 or media player 114 may then access the video from the storage and streaming provider 124 using the URL 118. This use case provides only one possible configuration. Many other configurations and use scenarios are possible using the systems and methods described herein.

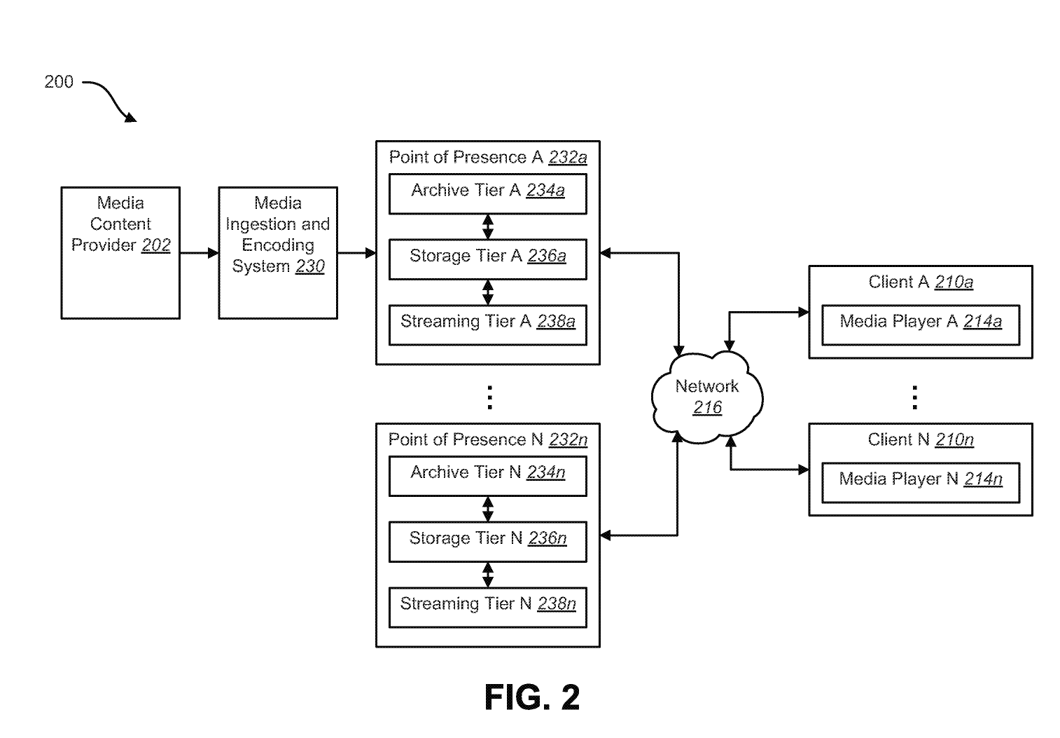

FIG. 2 is a block diagram illustrating a multi-tiered storage architecture 200 for storing and streaming content. A media content provider 202 may be connected to a media ingestion and encoding system 230, which in turn may be connected to point of presence A (POP) 232a. A number of POPs 232a-n may be connected to each other and to one or more clients 210a-n via a network 216 (e.g. an intranet or the Internet). The media content provider 202 provides media content. For example, the media content provider 202 may provide media content (e.g. audio, video) for streaming such that an end user of one of the clients 210a-n may consume (e.g. listen to, view) the media content. The media ingestion and encoding system 230 may receive media content from the media content provider 202. The encoding system 230 may encode the media content into a particular format and/or send it to a POP A 232a for storage and/or streaming.

The POPs 232a-n are systems where media content is stored and/or streamed to client computing devices 210a-n through the network 216. The POPs 232a-n may include archive tiers 234a-n, storage tiers 236a-n, and streaming tiers 238a-n. The archive tiers 234a-n have at least one storage device, such as a disk. For example, the archive tiers 234a-n may comprise “just a bunch of disks” (JBODs) for storing media content. That is, the archive tier may comprise modules or “bricks” that include disks for storing digital content. These modules may be placed on a rack. The storage tiers 236a-n include storage servers for storing media content. The streaming tiers 238a-n include streaming servers. The POP A 232a may receive encoded and/or formatted media content from the media ingestion and encoding system 230. The POP A 232a stores the encoded media content in the media archive tier A 234a and the storage tier A 236a. The POP 232a may also store or cache the media content on the streaming tier 238a. The media content may also be distributed via the network 216 to additional POPs 232n from the POP A 232a. For example, the POP N 232n may receive the encoded media data and store it on its corresponding archive tier N 234n, storage tier N 236n, and/or store (or cache) it on the streaming tier N 238n.

The media streaming tiers 238a-n may stream the media content to one or more clients 210a-n via the network 216 (e.g. intranet, the Internet). For example, POP A 232a may stream media content to client A 210a, while POP N 232n may stream media content to client N 210n. Additionally, a single client A 210a may concurrently stream media content from one or more POPs 232a-n. The clients 210a-n include media players 214a-n which play media content streamed from the POPs 232a-n.

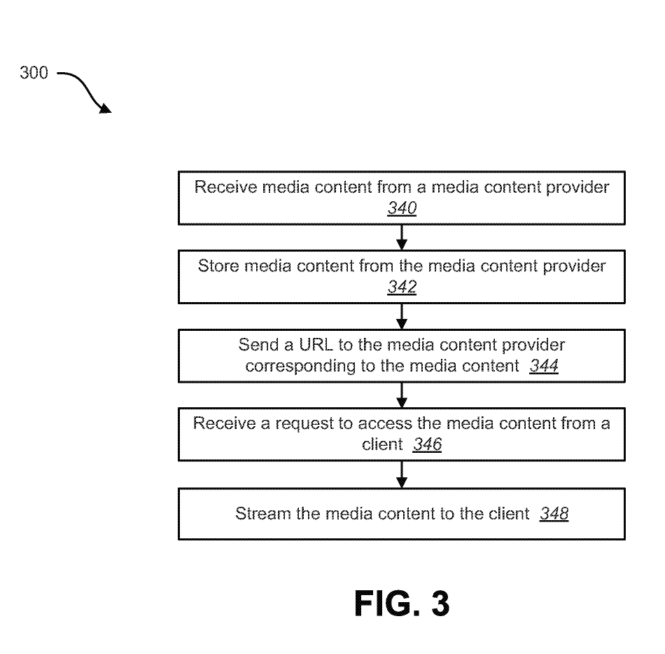

FIG. 3 is a flow diagram illustrating a method 300 for storing and streaming media content. A media content storage and streaming provider 124 may receive 340 media content from a media content provider 102. For example, a media content provider 102 uploads media content in the form of media files to the media content storage and streaming provider 124. The storage and streaming provider 124 stores 342 the media content. For example, the media content may be stored on one or more storage servers, in an archive, and/or optionally on one or more streaming servers. Specifically, the media content storage and streaming provider 124 may assign a “home” storage location (e.g. cluster) for the media content on a storage tier 236 so that the media content always appears at the “home” storage location.

The media content storage and streaming provider 124 may send 344 a URL to the media content provider 102 corresponding to the media content. For example, a URL that includes the address of the media content on the streaming and/or storage tiers 238, 236 may be sent to media content providers 102 for placement on their websites 104. The storage and streaming provider 124 may receive 346 a request to access the media content from a client 110. For example, it 124 may receive 346 a hyper text transfer protocol (HTTP) GET request from a client 110 at a URL corresponding to the media content address for a specific portion of the media content. For example, a client 110 might request a specific set of 100 bytes of a media content file located at a specified URL. In certain embodiments, the requested set of 100 bytes may be one portion (“chunk”) out of many portions requested by the client, where the client is able to intelligently and dynamically vary the size of portions requested. The URL may be directly translated into the media content address without lookup. The media content storage and streaming provider 124 may stream 348 the media content to the client 110 that requested the media content. For example, one or more streaming servers on a streaming tier 238a may stream 348 the requested media content. Additionally, media content may be streamed from multiple POPs 232a-n.

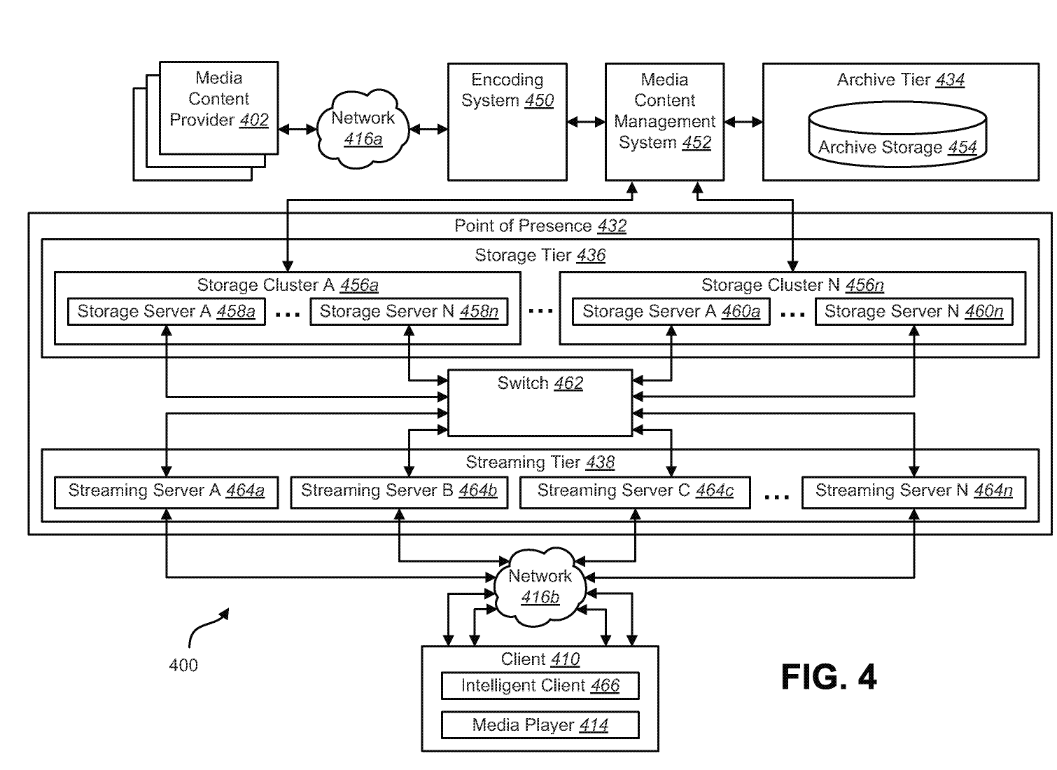

FIG. 4 is a block diagram illustrating a multi-tiered architecture 400 for storing and streaming media content. An encoding system 450 may be connected to a media content management system 452. The multi-tiered architecture 400 (i.e. the “storage structure”) may include an archive tier 434, a storage tier 436 and a streaming tier 438. The storage tier 436 and streaming tier 438 may be located within a POP 432. One or more media content providers 402 may send or upload media content to the storage structure for streaming media 400 via a network 416a (e.g. an intranet or the Internet). The encoding system 450 may transcode the content for streaming formats used by the storage structure for streaming media 400. Examples of different formats include, but are not limited to, MPEG (Moving Pictures Expert Group, including MP3, MP4, etc.), 3GPP (Third Generation Partnership Project), JTV (a proprietary format developed by Vusion), JTA (a proprietary format developed by Vusion), QuickTime® and .mov (proprietary formats developed by Apple), Windows Media® (a proprietary format developed by Microsoft), Flash® (a proprietary format developed by Adobe), and any other format that may suit a particular application of the principles described herein. The encoding system 450 may also replicate and format the media content for viewing at different resolutions and/or bit rates. For example, the media content formats may include a 720 p and a 480 p format. The media content management system 452 may assign addresses to different pieces of media content for storage on the storage structure 400 for streaming media content. In one possible configuration, a separate directory folder is created and named for each media content provider 402. The media content management system 452 may also create and name separate directory folders within the media content provider 402 folders for each piece of media content. A piece of media content may be a video, a music track, a picture, etc. Media content “assets” corresponding to each piece of media content may be stored in the media content directory folders. These “assets” may be files corresponding to the piece of media content. For example, the media content “assets” of a video may include different video file formats, bit rates, resolutions, corresponding audio files (e.g. of differing bit rates, languages, etc.), subtitle files (e.g. of different languages, etc.) “Assets” of a music track might be music file formats and bit rates, etc. Furthermore, “assets” of a picture may be different picture file formats, different corresponding audio files (e.g. for a slide show), different subtitle or text files (in different languages, etc.).

The media content may be stored on both the storage tier 436 and the archive tier 434. The storage structure for streaming media 400 includes one or more storage clusters 456a-n on the storage tier 436. Each of the storage clusters 456a-n includes one or more storage servers 458a-n, 460a-n. The media content management system 452 may assign one of the storage clusters 456a-n, 460a-n as a “home” storage cluster. For example, a “home” storage cluster A 456a is where a piece of media content is stored with a guaranteed location. Unless it is deleted from the system, a piece of media content will always be available on its “home” storage cluster A 456a (i.e., its storage address will remain the same). Although a piece of media content has a “home” storage cluster, it may also be distributed amongst additional storage clusters 456a-n. The media content may also be cached on one or more streaming servers 464a-n. The distribution of the media content may depend or be based on client 410 demand for the media content. Each piece of media content available on the storage structure for streaming media 400 is also stored in the archive storage 454 on the archive tier 434. Accessing the media content stored on the archive tier 434 generally has greater latency than accessing it on the storage tier 436. Storing the media content on the storage tier 436 in addition to the archive tier 434 may thus allow the streaming tier 438 to access stored media content with less latency. This may enable the streaming tier 438 to deliver the media content to the client 410 more rapidly. Furthermore, the 3-tiered architecture offers improved scalability over earlier architectures.

The storage structure 400 for streaming media content may include a switch 462 between the storage tier 436 and the streaming tier 438. The switch 462 connects the storage servers 458a-n, 460a-n to streaming servers 464a-n located on the streaming tier 438. The switch 462 facilitates the transfer of media content from the storage tier 436 to the streaming tier 438. The streaming servers 464a-n may stream media content to a client 410 via a network 416b (e.g. intranet, the Internet). The client 410 may include an intelligent client 466 and a media player 414. The intelligent client 466 is a hardware and/or software module that requests multiple portions of media content from one or more of the streaming servers 464a-n. For example, the intelligent client 466 may be configured to request multiple portions of a media content file, where the different portions have variable sizes. The intelligent client 466 may have embedded addresses (e.g. URLs, IP addresses) that indicate an address (e.g. a “base” address) for accessing the POP 432, the streaming tier 438 and/or storage tier 436. Thus, the intelligent client 466 may access a POP using an embedded address such that a Domain Name Service (DNS) lookup may not be necessary. The media player 414 plays streamed media content and is designed to read certain media content formats. The media player 414 may be part of the intelligent client 466. The client 410 may request and receive media content from multiple streaming servers 464a-n in order to sustain a sufficient bit rate and throughput such that the media content may be displayed jitter-free.

Media content that is being currently streamed (e.g. a working set) may be moved to the streaming servers 464a-n on the streaming tier 438. The storage structure 400 makes a “best effort” (i.e. best effort delivery) to move working set files onto streaming servers 464a-n. The ability to move the working set to the streaming tier 438 may be limited by the local disk capacity available on streaming tier 438. A copy of all media content ingested into the POP 432 is stored in the archive storage 454 in the archive tier 434. Some media content may be distributed on the storage clusters 456a-n based on replication rules specified by a media content provider (e.g. customer).

The architecture illustrated in FIG. 4 may alleviate bottlenecks between the storage tier 436 (i.e. storage servers 458a-n, 460a-n) and the streaming tier 438 (i.e. streaming servers 464a-n). More specifically, the storage structure for streaming media 400 may include the storage in the storage clusters 456a-n and also the local disk cache on the streaming servers 464a-n. Certain storage structure 400 components are responsible for content ingestion and replication across other POPs 232a-n and for moving and synchronizing content between the disk clusters 456a-n and the streaming server 464a-n caches.

The storage structure for streaming media content 400 may thus provide a scalable and high performance storage system. Specifically, it is designed as a single logical content repository implemented across multiple storage clusters 456a-n. It may also be distributed across multiple POPs 232a-n. While the storage structure 400 may include many storage clusters 456a-n, the content naming scheme that may be managed by the media content management system 452 along with storage structure 400 may allow storage to be viewed as a single large data store. The storage structure may thus be easily scaled up by adding new disk clusters.

Additionally, the storage structure 400 may be configured to be a multi-tenant repository partitioned across multiple media content provider (e.g. customer) 402 accounts. Specifically, when content from multiple media content providers 402 is ingested into the present system, content for each customer is kept separate from each other. Storage quotas may be applied on a per tenant basis.

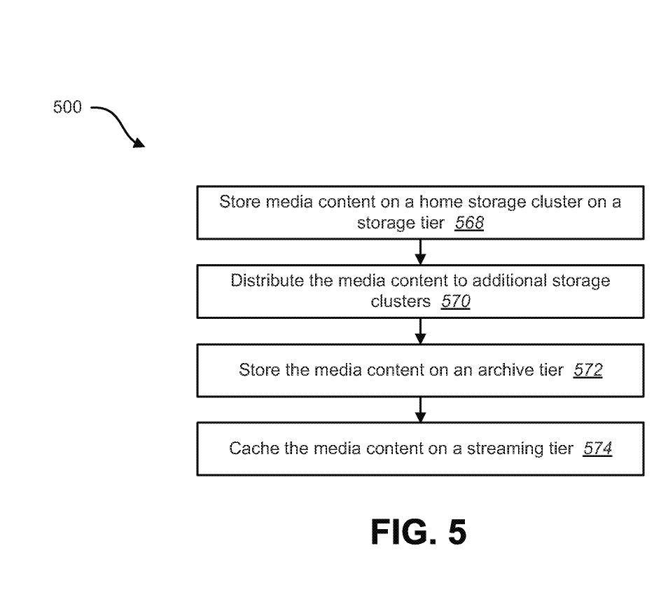

FIG. 5 is a flow diagram illustrating a method 500 for storing media content for streaming. A storage structure 400 may store 568 media content on a “home” storage cluster on a storage tier 436. Media content is received and stored 568 on an assigned “home” storage cluster A 456a. The storage structure 400 may further distribute 570 the media content to additional storage clusters. That is, the media content may be replicated on additional storage servers 460a-n. The storage structure 400 may also store 572 the media content on an archive tier 434. For example, the media content may be replicated from its “home” storage cluster A 456a to the archive storage 454 on an archive tier 434. Optionally, the storage structure 400 may cache 574 the media content on one or more streaming servers 464a-n on a streaming tier 438.

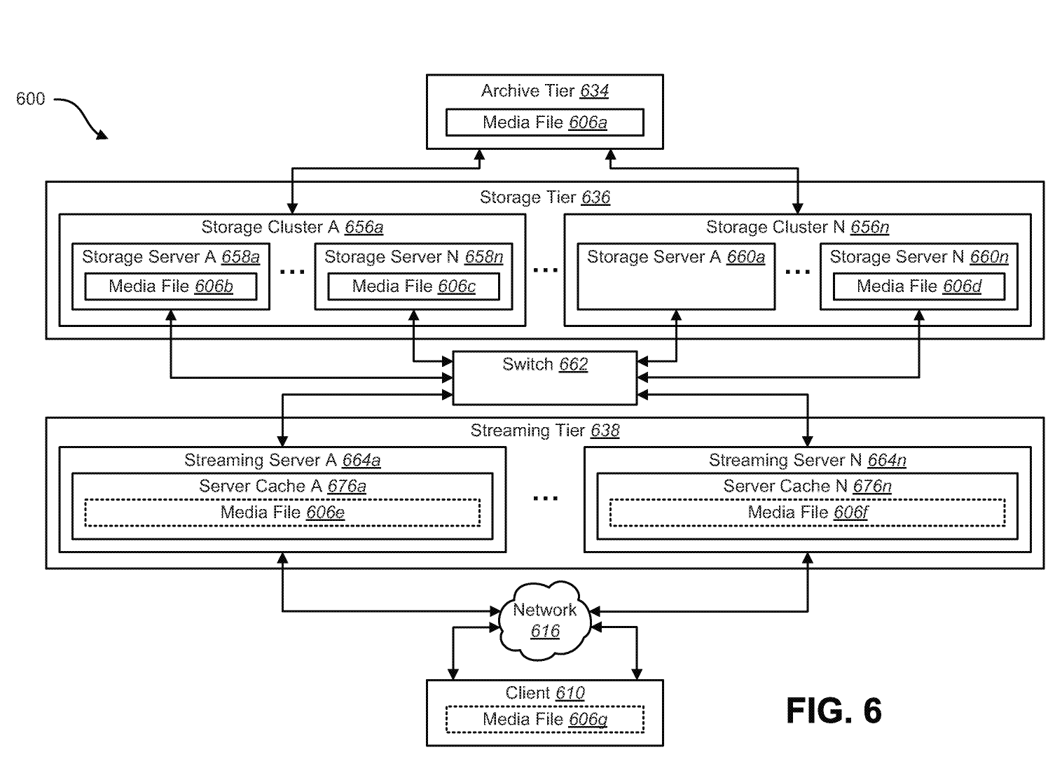

FIG. 6 is a block diagram illustrating the distribution of a media the in a storage structure 600 or system 600 for streaming media content. A storage tier 636 may include one or more storage clusters 656a-n. The storage clusters 656a-n include storage servers 658a-n, 660a-n. A media file 606 may be ingested into the storage structure 600 and assigned a “home” storage cluster (e.g. storage cluster A 656a) on the storage tier 636. The media file 606b-c is guaranteed to be available on its “home” storage cluster A 656a. If the media file 606 is not available on a streaming server 664a-n, for instance, it may be accessed on its “home” storage cluster A 656a. A “home” storage cluster identification (ID) or address may be part of a content name or Uniform Resource Locator (URL) such that the location of a “home” storage cluster may be efficiently determined by the system without any further lookup. The media file 606 may also be distributed to additional storage servers located in other storage clusters. One example is where the media file 606 is replicated on storage server N 660n on storage cluster N 656n. The degree to which a media content file 606 is replicated may depend on its popularity (in part). All media files stored in the storage structure 600, including the media file 606a, may also be copied on an archive tier 634.

The “home” storage cluster of a media file 606 may be assigned based on rules set up in the media content management system 452 (e.g. a Video Management System (VMS)) when a media content provider 402 account is created. All of the media content for a single media content provider 402 may have a home on the same cluster. Once content has been ingested into the storage structure 600, its “home” storage cluster may not be altered as this could result in invalid media URLs that are distributed out in the Internet on media content provider 102 websites 104. Even though the “home” cluster storage cluster may not be altered, the physical location of the cluster itself may be moved anywhere within the “media store” (e.g. across POPs 432).

The storage servers 658a-n, 660a-n may be connected to streaming servers 664a-n on a streaming tier 638 via a switch 662. The streaming servers 664a-n include server caches 676a-n. The server caches 676a-n may comprise large amounts of Random Access Memory. The server caches 676a-n may also comprise local hard disk space. Frequently accessed data that may be more costly (e.g. time consuming) to retrieve from its original storage location is stored in the server caches 676a-n. The server caches 676a-n may thus allow faster access to the media file 606. The media file 606b-d located on the storage tier 636 can be distributed to one or more server caches 676a-n. For example, the media file 606 may be distributed such that the media file 606e-f is cached in the server caches 676a-n. The client 610 requests the media file 606 via a network 616 (e.g. an intranet or the Internet). The media file 606 is streamed from one or more streaming servers 664a-n if the media file 606 is not located within the server caches 676a-n, then the media file 606b-d may be sent to the client 610 from one or more storage servers 658a-n, 660n via one or more streaming servers 664a-n. The storage structure 600 may cache the media file 606 on the streaming tier 638 (i.e. in one or more server caches 676a-n) in the process of fulfilling the request. The client 610 may display the media file 606g.

At a logical level the storage structure 600 may be viewed as single large repository. However, at a physical level the storage structure 600 may comprise multiple storage clusters 656a-n. At a physical level, storage may also be distributed over multiple POPs 232a-n. In order to maintain streaming performance, content may be available on a cluster at a POP 232a-n from where it is being streamed. Furthermore, if a system component needs to fetch specific media content that is not available in a local cache and storage cluster, it may fetch the file from its home storage cluster on another POP 232a-n.

In certain embodiments, a media file 606 received from a media content provider may be flagged as “hot” when the media file 606 is first uploaded to the storage structure 600. This “hot” flag may indicate to the storage structure 600 that the media file 606 has already been selected for storage and caching in the streaming tier 638. Thus, for example, a media file 606 that is anticipated to incur a large amount of demand, such as a new episode of a popular series, may be flagged as “hot” such that adequate resources are allocated to the media file 606 in anticipation of a large number of requests for that media file 606 from different clients 610. Additionally or alternatively, a media file 606 producer or originator may have the option to flag a media file 606 as “hot” in exchange for a higher hosting fee, even if it is not immediately anticipated that the media file 606 will incur a large amount of demand. This arrangement may be desirable to the producer or originator of the media file 606 due to the fact that the faster processors and network connections of the streaming servers 664 in the streaming tier 638 may provide a better viewing experience to a user than streaming the media file 606 from only the storage tier 636, particularly where the media file 606 is large or in high-definition.

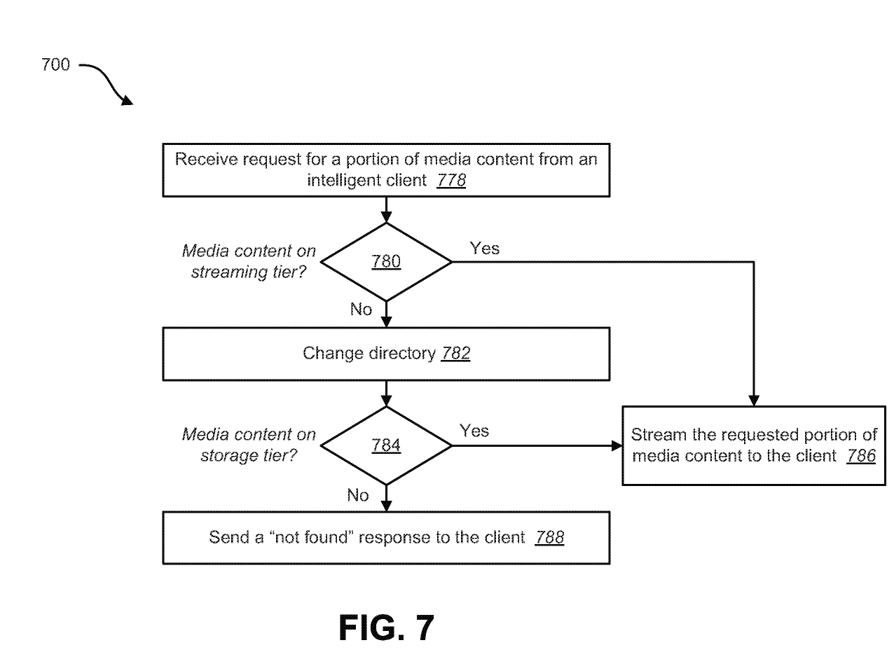

FIG. 7 is a flow diagram illustrating one possible configuration of a method 700 for streaming media stored on a multi-tiered storage structure. A media content storage and streaming provider 124 may receive 778 a request for a portion of media content from an intelligent client. More specifically, the media content storage and streaming provider 124 receives 778 a request for a specified number of bytes (e.g. a range of bytes in a media file 606) at a specified address on the storage structure 600. In certain embodiments, the number of bytes specified may vary with each request. Additionally or alternatively, one or more of the requests may specify the same number of bytes, but from different portions of the media file 606. For example, an intelligent client 466 sends an HTTP GET request to one or more streaming servers 664a-n at a particular URL. The URL contains an address that points to the location of a media file 606 on the storage structure 600. The URL is translated and appended to a directory that points to content on the streaming tier 638. That is, the directory may be generic to the server caches 676a-n on the streaming servers 664a-n.

The media content storage and streaming provider 124 may determine 780 whether the requested media content is currently cached or stored on the streaming tier 638. If the media content is currently cached or stored on the streaming tier 638, the media content storage and streaming provider 124 may stream 786 the requested portion to the client 610. In other words, the media content storage and streaming provider 124 may stream 786 the content to the client 610 via, one or more streaming servers 664a-n. If the media content is not currently cached or stored on the streaming tier 638, the media content storage and streaming provider 124 may change 782 the directory. For example, the media content storage and streaming provider 124 may change the directory that points to the streaming tier 638 to a directory that points to content on the storage tier 636.

The media content storage and streaming provider 124 may determine 784 whether the requested media content is stored on the storage tier. If the media content is stored on the storage tier 636, the media content storage and streaming provider 124 may stream 786 the requested portion of the media content to the client 610. If the media content is not stored on the storage tier 636, the media content storage and streaming provider 124 may send 788 a response to the client indicating that the requested media file was not found. For example, the media content storage and streaming provider 124 may send an HTTP 404 (e.g. “not found”) response to the client 610.

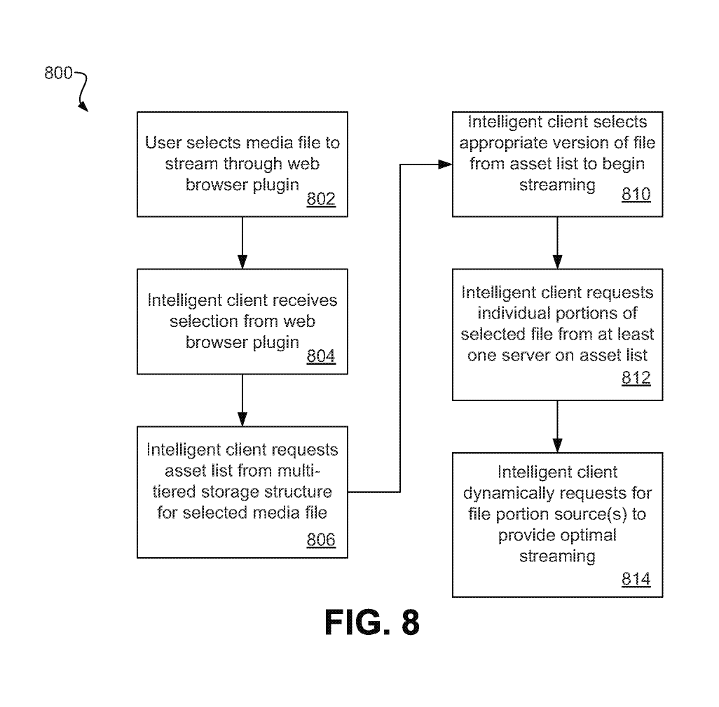

FIG. 8 is a flow diagram illustrating another possible configuration of a method 800 for streaming media stored on a multi-tiered storage structure 600 using an intelligent client 610. In this method 800, a user selects 802 a media file to stream through a web browser plugin. An intelligent client 610 in the user's computer receives 804 the selection from the browser plugin and requests 806 an asset list from the multi-tiered storage structure 600 corresponding to that particular media file. The asset list includes information about which versions of the selected media file are stored the multi-tiered storage structure 600.

For example, a user may select a video for streaming. The multi-tiered storage structure 600 may store one or more JTV file for the visual portion of the video and a JTA file for the audio portion of the video. Additionally, the multi-tiered storage structure 600 may store the same video as one or more MP4 (QuickTime®) files, or as one or more animated GIF files. One exemplary embodiment of this type of asset list is given as follows (written in Java Script Object Notation (JSON) format):

{“domains”:[ ],“assets”:
{“video”:[{“name”:“M1010exvBjdxCqEFkjFmeGyrqGqFFpkJ.jtv”,“format”:“jtv”,“bit
rate”:425,“framerate”:24,“width”:576,“height”:324,“default”:true},
{“name”:“M1010rxvBjdxhgEFkjFmeknjxquyrCBB.mp4”,“format”:“mp4”,“bitrate”:99
4,“framerate”:24,“width”:640,“height”:360,“default”:true},
{“name”:“M1010ixvBjdxEqEFkjFmemzGmrzGDwpH.mp4”,“format”:“mp4”,“bitrate”
:1359,“framerate”:24,“width”:640,“height”:360},
{“name”:“M1010oxvBjdxeqEFkjFmeFneynymqEmw.jtv”,“format”:“jtv”,“bitrate”:631
,“framerate”:24,“width”:640,“height”:360}],
“image”:[{“name”:“M1010\/xvBjdx\/qEFkjFme\/FFzmelbsxy.gif”,“format”:“gif”,“wid
th”:150,“height”:150,“default”:true}],
“audio”:[{“name”:“M1010sxvBjdxoqEFkjFmeIHxHjlgrJwm.jta”,“format”:“jta”,“bitrat
e”:125,“language”:“xx”,“channels”:“”,“default”:true}]}}

Thus, in the above example, the files stored by the multi-tiered storage structure 600 corresponding to the video may include:
1. A JTV video file with a bitrate of 425, a frame rate of 24, a width of 576 pixels, and a height of 324 pixels;
2. An H.264/MP4 file with a bitrate of 994, a frame rate of 24, a width of 640 pixels, and a height of 360 pixels;
3. An H.264/MP4 file with a bitrate of 1359, a frame rate of 24, a width of 640 pixels, and a height of 360 pixels;
4. A JTV video file with a bitrate of 631, a frame rate of 24, a width of 640 pixels, and a height of 360 pixels;
5. A GIF image file with a width of 150 pixels and a height of 150 pixels; and
6, A JTA audio file (which can be played together with either of the above JTV video files) having a bitrate of 125, and a language of “xx,”

The intelligent client may select an appropriate file from the asset list to begin streaming from the multi-tiered storage architecture 600. In certain embodiments, this selection may be determined based on the device on which the video is to be played. For example, in the above exemplary asset file, the larger, higher definition H.264/MP4 file may be more suitable for playing on a personal computer screen or a tablet computer (e.g., Apple Ipad®), whereas a smaller, lower bitrate, or lower definition H.264/MP4 file may be more suitable for playing on a personal media device (e.g., Apple Ipod® or Iphone®). Additionally or alternatively, the selection of which file to being streaming may be made based on the speed of a network connection.

Once the intelligent client has received the asset list from the multi-tiered storage structure 600, the intelligent client selects 808 an appropriate version of the media file from the asset list to begin streaming and requests individual portions of the selected version of the selected file from at least one server that stores that version of the file. For example, the intelligent client may begin by requesting different portions of a lowest resolution version of the file in a preferred format and assemble those portions such that the web browser plugin can play the video from the assembled portions of the file. As described above, in certain embodiments the intelligent client may dynamically vary the number of bytes requested in each portion according to the speed of the network, the server from which the portion is requested, how urgently a requested portion is needed to provide an uninterrupted viewing experience, and any other factor that may suit a particular embodiment of the principles described herein.

The intelligent client may have a built-in list of all servers or server clusters within the hierarchy of the multi-tiered storage structure 600. In certain embodiments, most or all media files will be replicated at each server in the multi-tiered storage structure 600. In such cases, the intelligent client may identify one or more servers in the multi-tiered storage structure 600 that are physically the closest in location to the intelligent client and initiate streaming with those servers to reduce the network latencies and receive the content faster. Additionally or alternatively, the intelligent client may prioritize streaming from streaming servers in the streaming tier 638 of the multi-tiered structure 600.

However, in other embodiments, it may be the case that not all of the servers in the multi-tiered structure 600 store files related to the video in all of the above formats or even at all. For instance, servers or clusters of servers in the streaming tier 638 may only store the video in the most popular format, while servers or clusters of servers in the storage tier 636 may collectively store the video in all of its supported formats. Thus, the intelligent client may be configured to first identify which servers or clusters of servers in the multi-tiered storage structure 600 store the desired file for streaming and make requests only from those servers or clusters of servers. Alternatively, the asset list received by the intelligent client may identify where all “assets,” or files linked to the selected video may be found within the architecture of the multi-tiered storage structure 600, along with information about each of the different formats. In certain embodiments, the asset list will be received from the home storage cluster in the storage tier for the desired video, as the home storage cluster may store all available versions of files associated with the video.

In certain embodiments, the intelligent client may request the same portions of the same file from redundant servers in the multi-tiered storage structure 600 to ensure the fastest deliver of the portions and allow for a faster streaming experience to the user. Additionally or alternatively, the intelligent client may request analogous portions of a high-resolution version of the video and a low-resolution version of the video such that if the high-resolution portion is received in time, that portion of the video will be played in high-resolution, whereas if a high-resolution portion of the video is not received in time, a received corresponding low-resolution version portion of the video will be played in its stead.

The intelligent client may dynamically update 814 its requests for file portions as needed to provide an optimal streaming experience. For example, as described in one embodiment above, the intelligent client may dynamically switch between high- and low-resolution versions of a video file according to the speed at which the requested portions of the video are received over the network. Additionally, the intelligent client may dynamically change the servers or clusters of servers from which portions of the selected video are requested, according to a determined connection speed to each server or cluster of servers. Thus, in some examples, the intelligent client may request the same portion of the same file from different servers or clusters of servers in the multi-tiered storage structure 600 to determine which of the servers or clusters of servers in the multi-tiered storage structure 600 respond the fastest. The intelligent client may thereafter direct more requests to the servers or clusters of servers having the fastest response times.

By dynamically adjusting the number of connections between the intelligent client and servers or clusters of servers in the multi-tiered structure, the sources from which portions of the selected video are requested, and the format and resolution of the files from which portions of the selected video are requested, the intelligent client may continuously provide the best possible file streaming experience to the user, irrespective of changing network conditions.

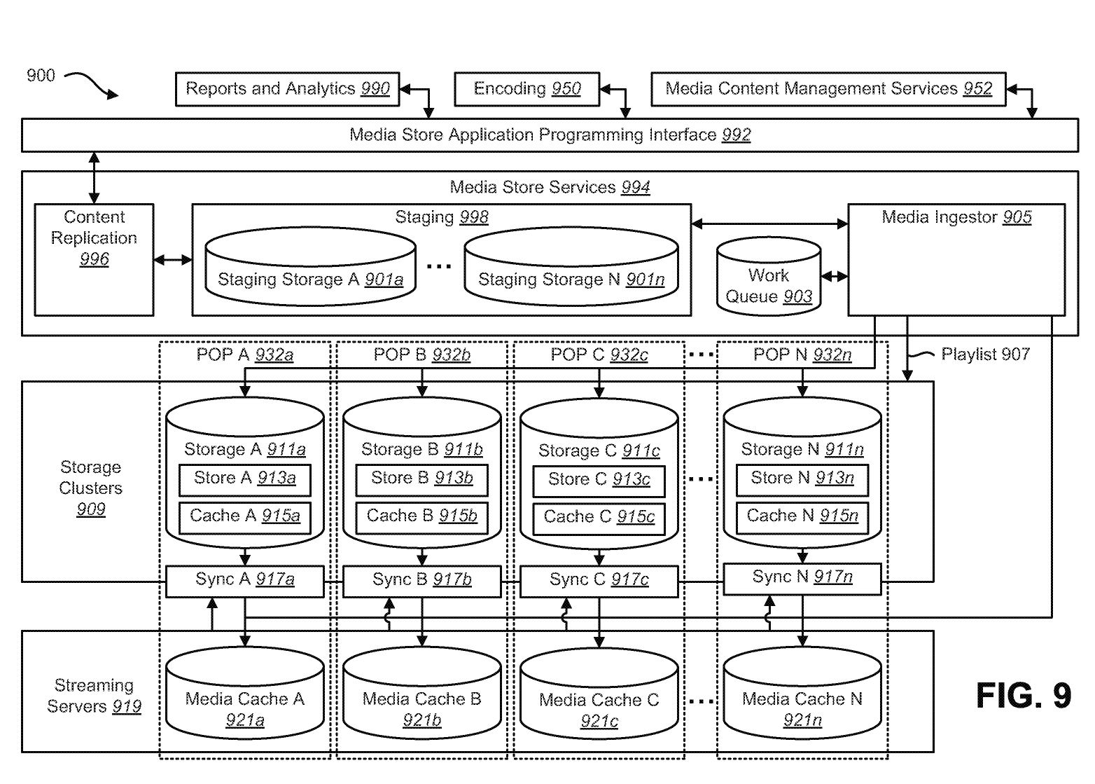

FIG. 9 is a block diagram illustrating media store services 900 provided by a media content storage and streaming provider 124. The media content storage and streaming provider 124 may include a reports and analytics module 990, an encoding module 950, a media content management services module 952, a media store application programming interface module 992, a media store services module 994, storage clusters 909 and streaming servers 919. The reports and analytics module 990, the encoding module 950, and the media content management services module 952 (e.g. VMS) use the media store application programming interface (API) 992 to use media store services 994. The media store API 992 provides calls that support a number of functions including, but not limited to: content ingestion, content status, content deletion, playlist ingestion, and set default asset. Media content is transcoded by the encoding module 950 to particular formats used by the media content storage and streaming provider 124. Optionally, media content that has already been encoded may bypass the encoding module 950. The media content management services module 952 may manage how media content is addressed and distributed throughout the media content storage and streaming provider 124.

A “media store” as referred to herein includes storage 911a-n on the storage clusters 909 as well as the media caches 921a-n on the streaming servers 919. Media store components are responsible for content ingestion and replication across the POPs 932a-n. Media store components are also responsible for moving content between the storage clusters 909 and the media caches 921a-n on the streaming servers 919. The media store services 994 may include a content replication module 996, staging module 998, media ingestor 905, and a work queue 903. The content replication module 996 may replicate content from a media content provider 102 into the staging module 998. The staging module 998 may store media content in staging storage 901a-n. At that point, the media ingestor 905 creates an entry in the work queue 903. The work queue 903 may be a database that includes a number of work items. For example, the work queue 903 includes a list of media content to be ingested into the storage clusters 909 and/or streaming servers 919. Other work items may also be included in the work queue 903 (e.g. a particular piece of media content needs to be replicated to another storage server, to another POP, etc.). The media ingestor 905 moves media content from staging storage 901a-n into the storage clusters 909 and/or the streaming servers 919 (of one or more POPs 932a-n). It 905 may also distribute the media content throughout the storage clusters 909 and/or the streaming servers 919 based on rules specified by a media content provider 102. For example, when a media content provider 102 anticipates a particular piece of media content to be popular in certain regions, the media content provider 102 may dictate that the media content should be distributed on certain POPs 932a-n. It may also be anticipated that a particular piece of media content will be heavily requested. According to media content provider 102 rules, the media content should be placed on one or more streaming servers 919.

The media ingestor 905 may provide a playlist 907 along with the media content. The playlist 907 includes a listing of files associated with a piece of media content. For example, the playlist 907 may include a listing of different video/audio format files (e.g. different resolutions, bitrates, different file formats such as Windows Media®, Flash®, etc.), audio files (e.g. different language audio files associated with video content, etc.), subtitle files, etc.

The storage clusters 909 include storage 911a-n modules for one or more POPs 932a-n. Each storage module 911a-n include a store 913a-n and a cache 915a-n. The streaming servers 919 may include one or more media caches 921a-n. The streaming servers 919 may interact with one or more synchronization daemons 917a-n (i.e. Labeled “Sync” in FIG. 9 for convenience). The synchronization daemons 917a-n may be responsible for replicating popular media content into the media caches 921a-n. This may provide an improvement in streaming performance. The synchronization daemons 917a-n are software components that are configured to use traffic statistics obtained from the streaming servers 919 and/or a media content profile (e.g. whether a video is expected to have a large number of streaming views or whether it is a long tail limited view content) to determine what media content needs to be available in the streaming server 919 media caches 921a-n.

While the media caches 921a-n may contain frequently accessed media content, the media content will also be available at a storage cluster 909 “home” location. This “home” location may be identified by a content ID or URL. During ingestion, the media content is placed on a “home” storage cluster and other clusters 909. Content may or may not be placed into the media cache 921 on streaming servers 919 during ingestion. The media content storage and streaming provider 124 may rely entirely on the media cache synchronization daemons 917a-n to selectively move and synchronize high demand content to the streaming server 919 media caches 921a-n based on viewing statistics and demand for the content. Alternatively, the system may rely on media content provider-specific replication rules in addition to the media cache synchronization daemons 917a-n in order to govern content ingestion and replication. That is, content ingestion and replication may be based on media content provider-specific replication rules that support replication of content directly across multiple storage clusters 909 in different POPs 932a-n. Furthermore, content that is expected to be in heavy demand may be placed in the streaming server media caches 921a-n according to the media content provider-specific replication rules in order to improve performance. Accordingly, a media content provider 102 may set a profile of specific content as likely to have high demand. When this content is ingested, the media ingestor may recognize the content as likely to have high demand and may place the content in a home storage cluster and directly replicate the content to a number of streaming servers 919.

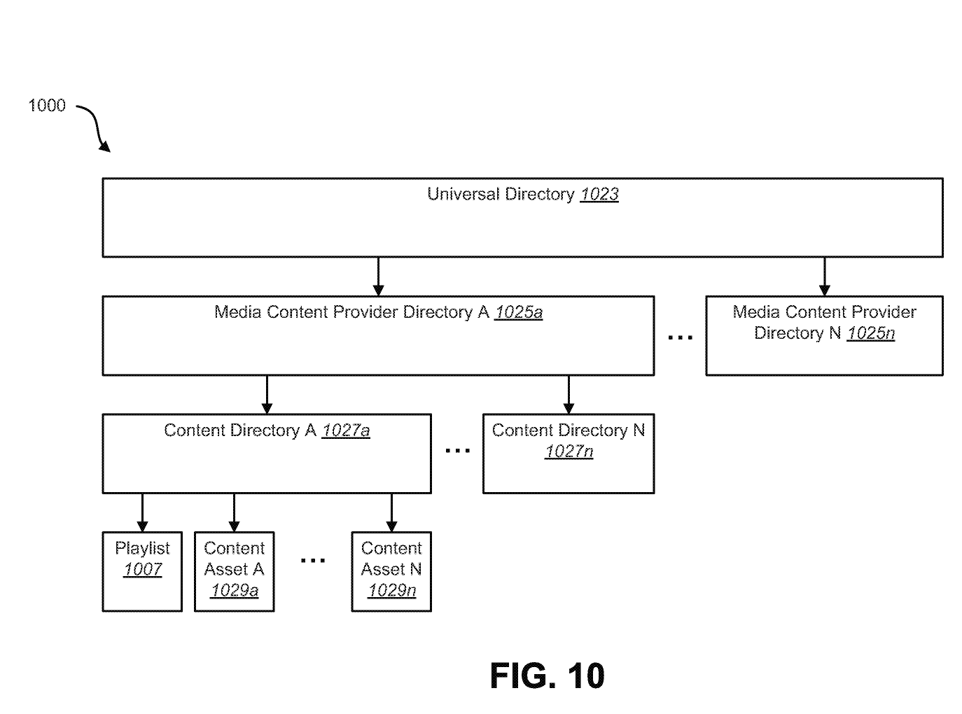

FIG. 10 is a block diagram illustrating a directory structure 1000. Media content storage may be implemented as a set of file system folders or directories on the storage tier 636 servers 658a-n and/or the streaming tier 638 streaming servers 664a-n. Each cluster 656a-n and/or storage server 658a-n may have a base path where the media storage is mounted. For example, media storage may be mounted as /www/M0002. M0002 is a universal cluster ID or directory 1023 that is used to mount storage on all storage servers 658a-n. Even though individual cluster IDs are assigned to storage servers 658a-n, these IDs may not be used internally while mapping storage. Consequently, the software components of the media content storage and streaming provider 124 may be cluster agnostic. Logical universal directories 1023 are used. For example, M0000 may be used for the server caches 676a-n on the streaming servers 664a-n, M0001 may link to content mounted on remote clusters, M0002 may be used for storage on the storage servers 658a-n, 660a-n (on the storage tier 636), and M0003 may be used for a statistics collection area. Media content addresses may be the same on both the storage tier 636 and the streaming tier 638, except that the universal directory (e.g. M000, M0002) 1023 may be different. There may be a separate media content provider directory 1025a-n for each media content provider 102 on a universal directory 1023. All content owned by a media content provider 102 may be placed in that media content provider's directory. The media content provider's directory (e.g. “folder”) may be named using a media content provider's ID assigned to the media content provider.

Each media content provider directory 1025a-n may include one or more content directories 1027a-n. Each piece of media content is placed in a single content director. That is, each content directory 1027a-n includes only files associated with a single piece of media content. For example, all of the files associated with a particular video (e.g. different formats, different resolutions, subtitles, audio tracks, etc.) might be placed in a content directory A 1027a for that particular video. Each of the content directories 1027a-n are named using a content ID assigned to the media content by the media content management system 452 (e.g. VMS) during ingestion. A content directory 1027a may include a playlist file 1007 and one or more content asset files 1029a-n (e.g. for video, audio, sub-titles, etc.). For example, the playlist file 1007 may be named “1st” and placed in the content directory A 1027a. Content assets 1029a-n may be files associated with a particular piece of media content. For example, assets may be video files, audio files, subtitle files, etc. Each content asset 1029a-n for a given piece of media content may have a unique content asset ID. Content asset files 1029a-n are placed in a content directory 1027a (e.g. “folder”). Each content asset file may have an entry in the playlist file 1007 that specifies the type of asset, bit rate and so on. This information is used by the media player 414 for playback.

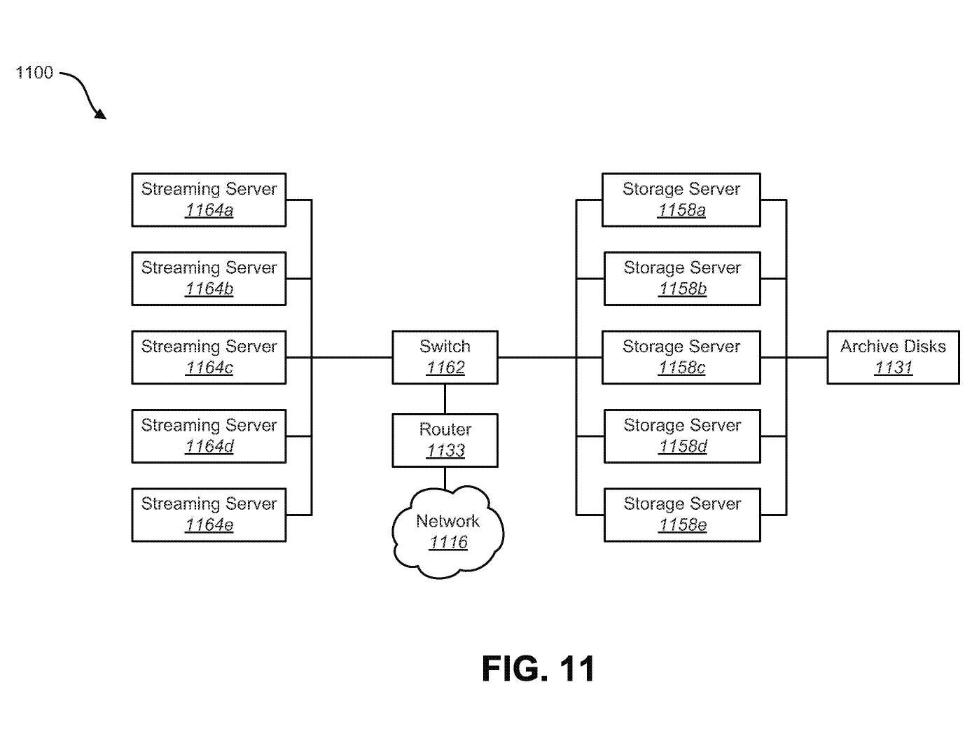

FIG. 11 is a block diagram illustrating various components 1100 that may be used in a storage structure for streaming media content. The storage structure may include archive disks 1131, one or more storage servers 1158a-e, a switch 1162, one or more streaming servers 1164a-e, and a router 1133. The archive disks 1131 may include many disks used for storing electronic data. In particular, the archive disks 1131 may include one or more “bricks” of disks. The archive disks 1131 may be mounted in a rack. The archive disks 1131 are connected to the storage servers 1158. The storage servers 1158 are computing devices used to receive, store, and transmit electronic data. The switch 1162 is an electronic device used to connect other electronic devices on a network. The streaming servers 1164 are electronic devices used to receive, store, and transmit electronic data. The streaming servers 1164 may be housed in neighboring racks and/or rack slots. The storage servers 1158 may be included in neighboring racks and/or rack slots. One or more of the streaming servers 1164 may be included in racks and/or rack slots neighboring one or more of the storage servers 1158. The archive disks 1131 may be included in racks and/or rack slots neighboring the storage servers 1158 and/or the streaming servers 1164. Furthermore, one or more of the streaming servers 1164, the switch 1162, the router 1133, one or more of the storage servers 1158a, and/or the archive disks 1131 may also be included in neighboring racks.

The streaming servers 1164 and storage servers 1158 are connected to the switch 1162. The switch 1162 may be connected to a router 1133. The router 1133 may be an electronic device used to route data between electronic devices on a network. The router 1133 may be connected to a network 1116 (e.g. intranet, the Internet). Although only five storage servers 1158a-e and five streaming servers 1164a-e are illustrated in FIG. 11, many more storage servers 1158 and streaming servers 1164 may be included in a storage structure for streaming media content. Although only one switch 1162 and one router 1133 are illustrated in FIG. 11, many more switches 1162 and routers 1133 may be included in a storage structure for streaming media content. Additionally, although only one block is used to illustrate the archive disks 1131 in FIG. 11, many collections or “bricks” of archive disks may be included in a storage structure for streaming media content.

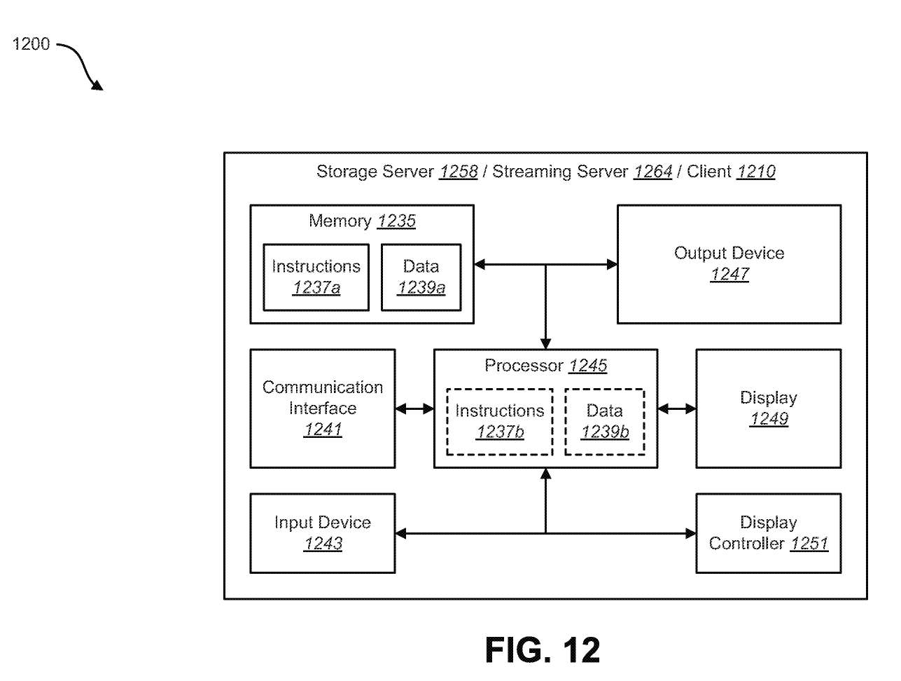

FIG. 12 illustrates certain components 1200 that may be included in a storage server 1258, streaming server 1264, and/or client 1210. The illustrated components may be located within the same physical structure or in separate housings or structures.

The storage server 1258, streaming server 1264, and/or client 1210 include a processor 1245 and memory 1235. The memory 1235 may include instructions 1237a and data 1239a. The processor 1245 controls the operation of the storage server 1258, streaming server 1264, and/or client 1210 and may be a general purpose single- or multi-chip processor, a special purpose processor (e.g. a digital signal processor (DSP)), a microcontroller, a programmable gate array, etc. The processor 1245 may be referred to as a central processing unit (CPU). Although just a single processor 1245 is shown in the storage server 1258, streaming server 1264, and/or client 1210 of FIG. 12, in an alternative configuration, a combination of processors could be used. The processor 1245 typically performs logical and arithmetic operations based on program instructions 1237b and/or data 1239b stored (1237a, 1239a) within the memory 1235.

The storage server 1258, streaming server 1264, and/or client 1210 also include memory 1235 in electronic communication with the processor 1245 (i.e., the processor 1245 can read information from and/or write information to the memory 1235). The memory 1235 may be any electronic component capable of storing electronic information. The memory 1235 may be a random access memory (RAM), read only memory (ROM), magnetic disk storage media, optical storage media, flash memory devices in RAM, on-board memory included with the processor, programmable read-only memory (PROM), erasable programmable read only memory (EPROM), electrically erasable PROM (EEPROM), registers, and so forth, including combinations thereof.

Data 1239 and instructions 1237 may be stored in the memory 1235. The instructions 1237 may include one or more programs, routines, sub-routines, functions, procedures, etc. The instructions 1237 may include a single computer-readable statement or many computer-readable statements. The instructions 1237 may be executable by the processor 1245 to implement the methods that are described herein. Executing the instructions 1237 may involve the use of the data 1239 that is stored in the memory 1235. FIG. 12 shows some instructions 1237a and data 1239a being loaded into the processor 1245.

The storage server 1258, streaming server 1264, and/or client 1210 typically may include one or more communication interfaces 1241 for communicating with other electronic devices. The communication interfaces 1241 may be based on wired communication technology, wireless communication technology, or both. Examples of different types of communication interfaces 1241 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The storage server 1258, streaming server 1264, and/or client 1210 typically may include one or more input devices 1243 and one or more output devices 1247. Examples of different kinds of input devices 1243 include a keyboard, mouse, microphone, remote control device, button, joystick, trackball, touchpad, lightpen, etc. Examples of different kinds of output devices 1247 include a speaker, printer, etc. One specific type of output device which may be typically included in a computer system is a display device 1249. Display devices 1249 used with the configurations disclosed herein may utilize any suitable image projection technology, such as a cathode ray tube (CRT), liquid crystal display (LCD), light-emitting diode (LED), gas plasma, electroluminescence, or the like. A display controller 1251 may also be provided, for converting data stored in the memory 1235 into text, graphics, and/or moving images (as appropriate) shown on the display device 1249.

Of course, FIG. 12 illustrates only one possible configuration of a storage server 1258, streaming server 1264, and/or client 1210. Various other architectures and components may be utilized.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “computer readable storage medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. The term “computer readable storage medium” expressly does not encompass a signal per se or any nontangible article.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for providing media content, comprising:
storing a plurality of media files on a storage tier comprising at least one storage cluster, each said storage cluster comprising at least one server;
replicating at least some of said media files stored on said storage tier on at least one streaming server of a streaming tier configured to stream data over a network faster than said storage tier is able to stream said data over said network;
receiving a request from a client over said network for a portion of a selected media file;
streaming said requested portion of said selected media file to said client from said streaming tier if said selected media file is stored on said streaming tier; and
streaming said requested portion of said selected media file to said client from said storage tier if said media file is not stored on said streaming tier.

2. The method of claim 1, wherein:
said storage tier comprises a plurality of storage clusters; and
said storing said plurality of media files on said storage tier comprises continually storing each media file on at least an assigned home storage cluster for said media file in said storage tier, wherein an address of said home storage cluster of said media file remains static.

3. The method of claim 1, wherein said media files replicated on said streaming tier are selected for replication on said streaming tier according to at least one of: an anticipated demand associated with said media files replicated on said streaming tier, a current demand for said media files replicated on said streaming tier, and streaming traffic statistics associated with said media files replicated on said streaming tier.

4. The method of claim 1, further comprising replicating at least some of the media files stored on said storage tier across multiple said storage clusters.

5. The method of claim 1, wherein said request comprises a specified a range of bytes in said selected media file.

6. The method of claim 1, further comprising archiving all of said media files on an archive tier comprising at least one memory, said archive tier being communicatively coupled to said storage tier.

7. The method of claim 1, wherein said at least one storage cluster in said storage tier and said at least one streaming server the storage tier and the streaming tier are communicatively connected by a network switch.

8. The method of claim 1, wherein said media files are selected from a group consisting of video files, audio files, picture files and subtitle files.

9. The method of claim 1, further comprising storing, in at least said storage tier, different media files corresponding to different versions of a single piece of video content, said different media files being selected from a group consisting of video files in differing resolutions, video files in differing bit rates and video files in differing file formats.

10. The method of claim 1, further comprising storing, in at least said storage tier, different media files corresponding to different versions of a single piece of audio content, said different media flies being selected from a group consisting of: audio files in differing languages, audio Ides in different bit rates, and audio files in differing file formats.

11. A system configured to store and stream media content, comprising:
a storage tier comprising a plurality of storage clusters, each of said storage clusters comprising at least one server, said storage clusters collectively storing a plurality of media files; and
a streaming tier communicatively coupled to said storage tier, said streaming tier comprising a plurality of streaming servers that collectively replicate at least some of said media files stored by said storage tier;
wherein each of said storage clusters in said storage tier and each of said streaming servers in said streaming tier is communicatively coupled to a network; and
wherein said streaming servers in said streaming tier are configured to stream data over said network faster than said storage tier is able to stream said data over said network.

12. The system of claim 11, wherein each of said plurality of media files stored on said storage tier comprises a permanently assigned home storage cluster for said media file in said storage tier, wherein an address of said home storage cluster of said media file remains static irrespective of hardware implementing said home storage cluster.

13. The system of claim 11, wherein said media files replicated on said streaming tier are selected for replication on said streaming tier according to at least one of: an anticipated demand associated with said media files replicated on said streaming tier, a current demand for said media files replicated on said streaming tier, and streaming traffic statistics associated with said media files replicated on said streaming tier.

14. The system of claim 11, wherein at least some of the media files stored on said storage tier are replicated across multiple said storage clusters.

15. The system of claim 11, further comprising an archive tier communicatively coupled to said storage tier, said archive tier comprising at least one memory configured to store all said media files stored on said storage tier.

16. The system of claim 11, wherein said at least one storage cluster in said storage tier and said at least one streaming server the storage tier and the streaming tier are communicatively connected by a network switch.

17. The system of claim 11, wherein said media files are selected from a group consisting of video files, audio files, picture files and subtitle files.

18. The system of claim 11, wherein at least said storage tier comprises different stored media files corresponding to different versions of a single piece of video content, said different media files being selected from a group consisting of video files in differing resolutions, video files in differing bit rates and video files in differing file formats.

19. The system of claim 11, wherein at least said storage tier, different stored media files corresponding to different versions of a single piece of audio content, said different media files being selected from a group consisting of: audio files in differing languages, audio files in different bit rates, and audio files in differing file formats.

20. A computer program product, comprising:
a computer readable storage medium, said computer readable storage medium comprising computer readable program code embodied therewith, said computer readable program code comprising:
computer readable program code configured to store a plurality of media files on a storage tier comprising at least one storage cluster, each said storage cluster comprising at least one server;
computer readable program code configured to replicate at least some of said media files stored on said storage tier on at least one streaming server of a streaming tier configured to stream data over a network faster than said storage tier is able to stream said data over said network;
computer readable program code configured to receive a request from a client over said network for a portion of a selected media file;
computer readable program code configured to stream said requested portion of said selected media file to said client from said streaming tier if said selected media file is stored on said streaming tier; and
computer readable program code configured to stream said requested portion of said selected media file to said client from said storage tier if said media file is not stored on said streaming tier.
